(19) United States
(12) Patent Application Publication
(10) Pub. No.: US 2017/0284107 A1
(43) Pub. Date: Oct. 5, 2017

(54) Mortar-less decorative tile mosaic composite for swimming pool bottom

(71) Applicants: Christian David Trinidade, Chelmsford, MA (US); Katharine Elizabeth Slowe, Chelmsford, MA (US)

(72) Inventors: Christian David Trinidade, Chelmsford, MA (US); Katharine Elizabeth Slowe, Chelmsford, MA (US)

(21) Appl. No.: 15/479,254

(22) Filed: Apr. 4, 2017

Related U.S. Application Data
(66) Substitute for application No. 62/317,843, filed on Apr. 4, 2016.

(51) Int. Cl. E04F 15/02; E04H 4/14; B32B 9/04; B32B 5/02; B32B 9/00; E04F 15/08; B32B 3/16

(52) U.S. Cl. CPC E04F 15/02177; E04F 15/02155; E04F 15/087; E04H 4/14; B32B 3/16; B32B 5/028; B32B 9/005; B32B 9/047; B32B 2250/02; B32B 2260/021; B32B 2260/048; B32B 2307/744; B32B 2262/101; B32B 2255/02; B32B 2255/26; B32B 2471/00

(57) ABSTRACT

Preformed and self-contained ceramic tile mosaic composite that contact adheres to swimming pool bottoms without tools or a need to drain water. This invention in unique in that it allows for easy tool-free installation in the bottom pools full of water. This invention is also unique in that it allows for installation in soft shell pools (i.e. vinyl liner, in-ground and above ground) as well as concrete based and fiberglass pools. Another differentiator is that this invention is flexible and conforms to the bottom of the pool. This provides full surface interface of the rubber base and pool bottom. The rubber base is designed to be tractable and can provide some degree of suction allowing the composite to keep intended form, shape, position and location without the permanence of a cementitious or epoxy/glue adhesive necessitated by typical mesh mounted pool tile mosaics. This invention also allows

### RELATED APPLICATIONS

a. Provisional patent application 62/317,843

### FEDERALLY SPONSORED RESEARCH

a. No portion of this project was federally funded

### SEQUENCE LISTING

a. There is no sequence listing for this application

### BACKGROUND

a. Currently there are decorative ceramic tile mosaics mounted on some sort of mesh or delivered in individual pieces that are designed to be adhered to the surface of empty/dry swimming pools, typically via a curing cementitious paste formula in a concrete based pool or by a curing epoxy/glue material in non-concrete based pools. Unfortunately, this usually limits the installation window to time of original construct or time of a rebuild that requires the pool to be drained. Those so determined can try to install these traditional mounted mosaics without draining the pool, but finding a proper bonding material and grout for an underwater install is not trivial and the labor under water is not ideal. Few tile installers are interested in such a challenge. Regardless, the typical tile mosaics on mesh are designed to be adhered to the bottom of a pool via an introduced cementitious or epoxy/glue bonding agent so the mosaic will not move around from the location intended or fold over itself due to water movement.

Our solution, a ceramic tile mosaic composite that contact adheres to the pool bottom, does not need the pool to be drained or necessitates the use of a cementitious or epoxy/glue like adhesive to stay where intended due to water movement.

b. The adhesive media between the ceramic mosaic and the pool shell that prevents the current ceramic mosaics from moving or folding over or otherwise distorting also prevents the pool owner from relocating or removing the ceramic mosaic. Removal of the current ceramic mosaic requires the compromise of the adhesive interface between the ceramic tile mosaic bottom and the pool mounting surface. Removal of the current ceramic tile mosaic offerings likely involves damaging the aesthetics of the pool surface at the mosaic location. Removal of the current ceramic tile offerings would preferably take place in a drained pool. The effort to remove a current ceramic mosaic from prior install would likely damage the ceramic mosaic to a point where relocation in another part of the pool or into another pool would not be ideal. Our solution, a ceramic tile mosaic composite that contact adheres to the pool bottom, would allow for removal or relocation without the need of tools or risk to pool shell surface. Simply dig fingers under one edge of mosaic and lift creating a degree of buoyancy that will allow for damage free transport to another part of the pool or out of the pool for relocation to a pool elsewhere.

### SUMMARY

This invention allows for the ceramic pool tile mosaics to be installed by the pool owner in any swimming pool of water. This invention employs a silicone substance between each tile segment through to the silicone and mesh base. The weight of the mosaic composite gets enhanced by the weight of the water, forcing the silicone substance between the tile segments to expand from the glazed tile segments on top of the composite to the direction of the silicone/mesh base. This allows the mosaic composite to conform to the bottom of the pool, allowing the complete surface area of the silicone rubber/mesh base to interface with the pool bottom. The silicone rubber substance between the tile segments of the mosaic and the silicone rubber/mesh compound enables it to keep the form intended by the artist and mosaic manufacturer regardless of water movement. The traction and in many cases suction provided by the silicone rubber/mesh base of the mosaic composite maintains desired location of the installer. These are significant improvements to the existing system in that no draining of the pool is required, no adhesive is needed to maintain intended form or placement and soft shell (i.e. vinyl liner) pools are not excluded.

### DESCRIPTION OF DRAWINGS

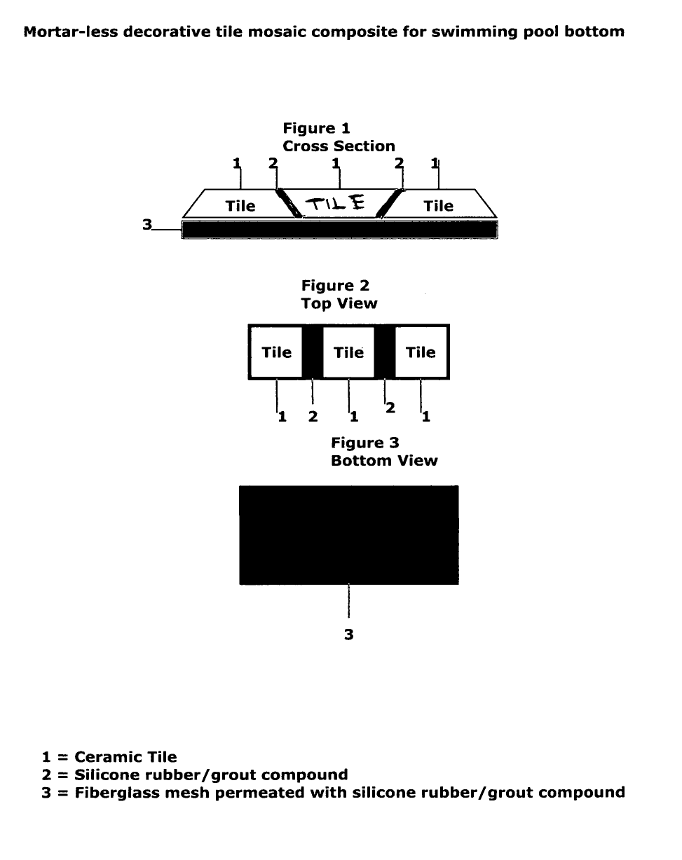

a. FIG. 1: Cross section of composite showing three layers. A top layer consisting of a tile mosaic laid flat with silicone attaching each tile within the mosaic edge to edge and reaching though to layer two. A second layer of mesh permeated by the same silicone material used in layer one. Then a third layer consisting of just the silicone material.

b. FIG. 2: Is a top view of the composite showing the tile mosaic with the silicone substance in between the tile segments.

c. FIG. 3: Is a bottom view showing the silicone substance base that makes up the third layer.

### DETAILED DESCRIPTION

This invention is a composite made up of a flat top layer of glazed ceramic tile segments (arranged as desired) adhered to mesh, then a silicone based substance is applied between the interior tile segments, down through to the bottom of the mesh. The same silicone rubber based material is then applied to the non-glazed tile/mesh base completing the composite. The silicone based rubber material between the tile segments of this invention keep the mosaic arrangement as intended by maintaining adherence between the tile pieces upon movement, expansion, or contraction whereas current mosaics have tile segments dislodge, fold over the mosaic or misalign on their mesh upon the same movements. The silicone based/mesh base of the mosaic composite provides a tractive and sometimes vacuumed interface that allows for maintaining desired placement without the use of a cementitious or epoxy glue adhesive that a current mosaic would need to prevent water movement from unintended relocation or position. Because this mosaic composite is preformed, self-contained and not needing of any adhesive as current mosaics do, the applicator can easily install without draining the pool of water and with no tools.

This is in contrast to installing current pool mosaics that require draining the pool dry to apply adhesive or impractical underwater adhesive effort.

The mosaic composite is designed to be placed in a minimum of 36 inches of water to achieve the desired weighting. Once placed in a pool and under water the flex of the silicone/grout allows for the pool mosaic to traction and suction to the bottom of the pool and not move even when pool vacuums go over them or the pool water becomes turbulent.

1. It is our claim that this flexible pre-formed self-contained tile mosaic composite is unique. This flexible pre-formed self-contained tile mosaic composite can be installed on any pool bottom regardless of hard or soft shell as well as whether the pool is empty or not, increasing the opportunity for a pool owner to enjoy a mosaic in their pool. In contrast, current mosaics require an adhesive media to maintain intended arrangement, shape, location and position while in the pool this is most practically done on the rare occasions that the pool is dry and only in hard shell pools (concrete based, fiberglass) and not at all on liner based pools.

2. The pre-formed self-contained tile pool mosaic eliminates the need to drain a mature pool dry and refill the pool to install it as it is designed to be placed in a full pool by the pool owner rather than a contractor or skilled worker.

3. Another unique characteristic of the pre-formed self-contained mosaic is flexibility. The flexibility is crucial to the ability of the self-contained pool tile mosaic to conform to the pool bottom and enable it
